(19) United States
(12) Patent Application Publication
(10) Pub. No.: US 2011/0042463 A1
(43) Pub. Date: Feb. 24, 2011

(54) Numeric Keypad Embedded Bar Code Scanner

(76) Inventor: I-Yu CHEN, San-Chung City (TW)

Correspondence Address: HDLS IPR Services, PO Box 220746, Chantilly, VA, 20153, US

(21) Appl. No.: 12/545,861

(22) Filed: Aug. 23, 2009

(51) Int. Cl. G06K 7/10

(52) U.S. Cl. 235/462.43

(57) ABSTRACT

A bar code scanner with an embedded numeric keypad to input quantity includes a bar code scanner and a set of keypad buttons. The keypad has a plurality of buttons arranged in a matrix and each button represents a specific number or an input function. The user can count the quantity of an item and input the number from the keypad before or after scanning it to store the correct quantity of such item. This can avoid entering quantity at the register or POS machine and simplifies the operation.

### BACKGROUND OF THE INVENTION

1. Field of the invention

This invention relates to a bar code scanner being special for having a numeric keypad embedded on it and the keypad buttons are arranged and programmed to help users to operate easily and scan multiple items with different quantity, so as to save the time for entering quantity at the registry or POS (point of sale) machine and avoid unnecessary operating errors to speed up the cashier process.

2. Description of the Prior Art

The common-used bar code scanner 5 as illustrated in FIG. 6 has a handle 51 and a bar code reader 52. The bar code reader 52 is positioned at the front end of the handle 51. User holds the handle 51 and aimed the bar code reader 52 close to a bar code, the bar code reader 52 scans the bar code with the optical sensor inside it, converts the scanned bar code into digital data, and compares the data with the database to obtain useable data.

When an item has a bar code that represents its information on it, user can use the common bar code scanner 5 to quickly obtain its data without manual work to save time especially when counting multiple items. This bar code scanner 5 is a must-have for mercantile, warehouse management, cashier, and many other places.

This common used bar code scanner 5 is rarely improved although it has been used for so long. Most of the research and developments are within improving the optical scanning/reading technology and the database system but not on the bar code scanner 5 itself.

Bar code scanner can be divided into two types. The first is the usual bar code scanner and the second is the common data collector, also known as handy terminal.

The bar code scanner 5 is mainly used for counting multiple different items so theoretically every single item should be scanned once to meet this purpose, but in order to save time, if the quantity of an item can be quickly counted, user can just scan the item once and enter the quantity of it on the cashier machine or the POS keypad before or after scanning it, and the system will have the data and correct quantity of the item. This scenario is very usual at any retail store and supermarket. When a customer purchased many items with different quantity, if the cashier scans every single item, it not only takes more time, the receipt is also hard to read.

The drawback of the common bar code scanner 5 is that it has no number input buttons. To enter the quantity of an item is done by the backend cashier connected to the bar code scanner 5. Which means the user must put down the bar code scanner after counting the quantity, punched in the number, and pick up the bar code scanner again to scan the next item. The only problem of this method is it is not convenient and takes more time.

The data collector is designed for storing the quantity of items. While having numeric buttons to enter quantity, the data must be transferred to the backend system to be used and processed. It is good for inventory control but does not help retail or supermarket checkout.

In conjunction with the space for the bar code scanner, to be more user friendly, and minimize the adopting time, this invention can be programmed and with different keypad layout to suite different situation and usage. This invention of bar code scanner with numeric keypad is developed and invented based on long term research and investigation.

### SUMMARY OF THE INVENTION

The primary objective of this invention is to provide a numeric keypad embedded bar code scanner which simplifies working process, increase scanning efficiency, and to quickly count and obtain data for multiple items with different quantity.

The further objective of this invention is to provide a numeric keypad embedded bar code scanner to reduce redundant body movement such as putting down the scanner, entering the quantity to the cashier machine, and picking up the scanner again. By minimizing these movements will also reduce human errors.

Yet another objective of this invention is to provide a numeric keypad embedded bar code scanner which is easy to use so the users do not need to spend too much time on learning it, or even program the buttons for their scenario to use the bar code scanner effectively.

The numeric keypad embedded bar code scanner that serves the described purposes has a bar code scanning device and a set of a plurality of buttons arranged in matrix embedded on the surface of the scanner. Each keypad button represents a specific number or function. Users confirm the quantity of an item and enter the number of the item before or after scanning it to record the correct quantity for an item to avoid entering the number at the registry or the POS machine to simply the process.

### BRIEF DESCRIPTION OF THE DRAWINGS

FIG. 1 shows a perspective view of this invention of numeric keypad embedded bar code scanner;

FIG. 2 shows a vertical view of this invention of numeric keypad embedded bar code scanner;

FIG. 3 shows this invention of numeric keypad embedded bar code scanner with integrated LED indicator on each numeric button;

FIG. 4 shows this invention of numeric keypad embedded bar code scanner with integrated LCD or LED display screen;

FIG. 5 shows an usage example of this invention of numeric keypad embedded bar code scanner; and

FIG. 6 shows an usage example of common bar code scanner.

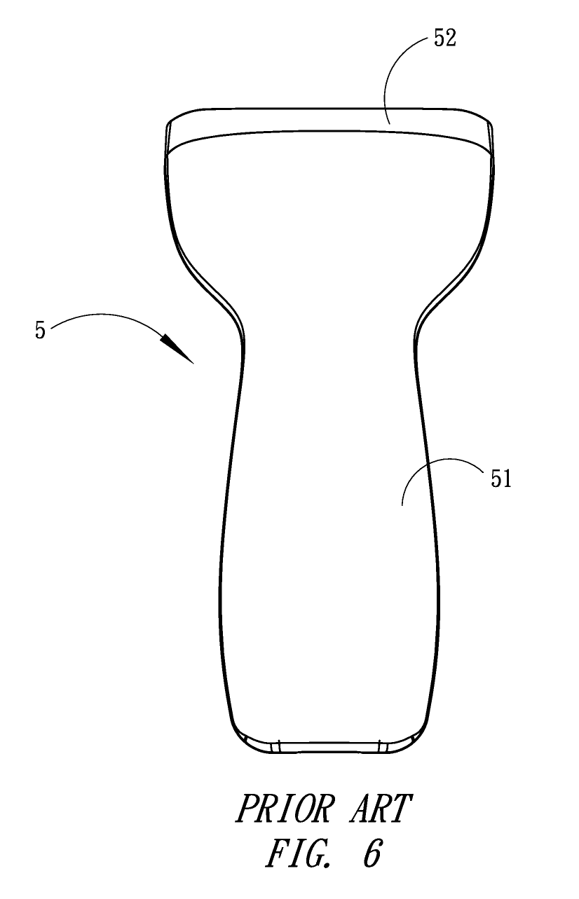

### DETAILED DESCRIPTION OF THE PREFERRED EMBODIMENT

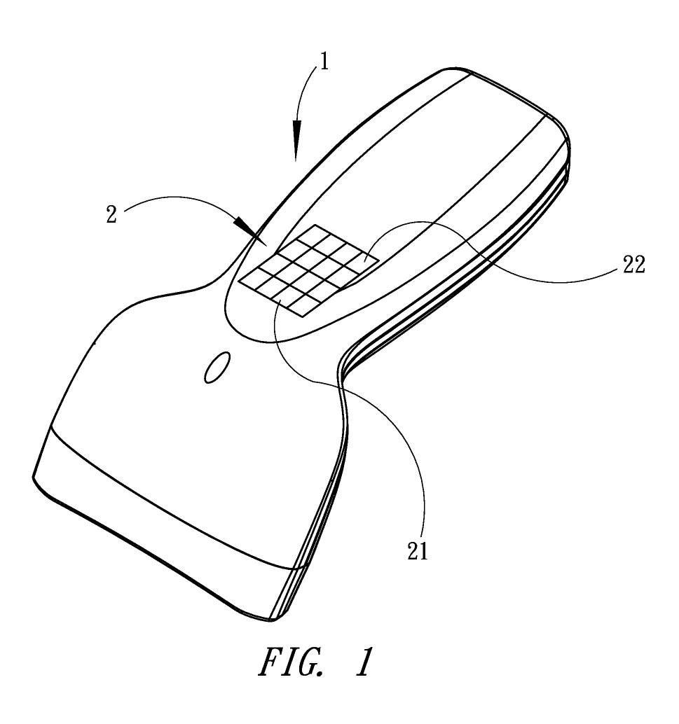

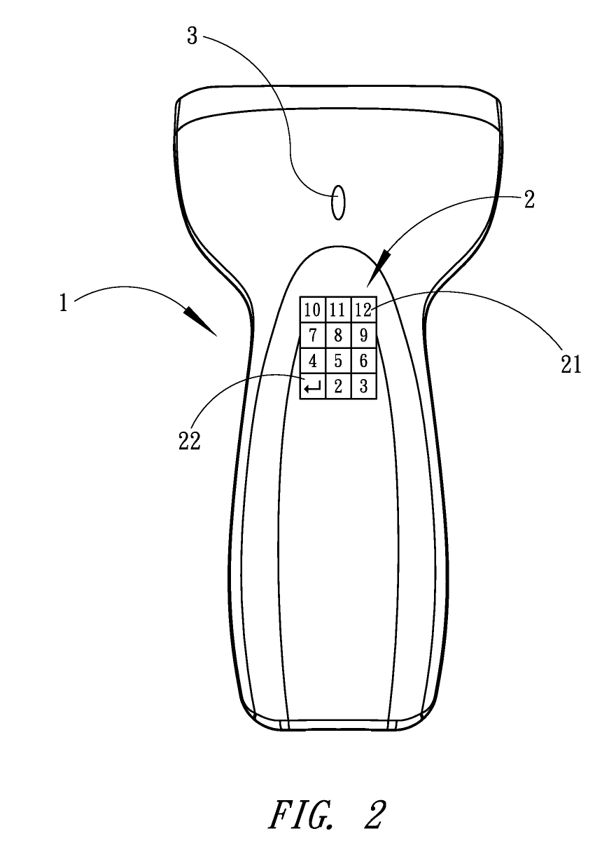

FIG. 1 and FIG. 2 show the numeric keypad embedded bar code scanner of this invention. It has a bar code scanner 1 and a set of keypad 2 embedded on it.

The bar code scanner 1 is the same as common bar code scanner as seen in the market so there will be no further description. What is special for this invention is the design of the keypad 2. This set of keypad 2 buttons is positioned on the surface of the bar code scanner 1 where it is easy to read and press, usually on the top surface of the bar code scanner 1. This keypad 2 has a plurality of buttons lined up to form a rectangular as seen in common keypads. There is no limitation in number of buttons or the size. To be convenient to the user is the primary concern. This example 1 as shown in FIG. 2 has 12 buttons which include 11 numeric buttons 21 representing number 2 to 12 and a confirm button 22. This arrangement is based on most customers seldom buy more than 12 of a single item. So if the quantity is one, just scan it and no need to use the keypad and when the quantity is more than one, user can scan it and press the number buttons 21 for the quantity before or after scanning it and followed by pressing the confirm button 22 to complete the process.

The layout concept of keypad 2 is easy-to-use and less learning time. Since each individual user might has his own habit or need, one single configuration for keypad 2 may not fulfill user's requirement, the integrated numeric keypad 2 uses the matured programmable module technology for the user to program each button according to his habit and fulfill his need.

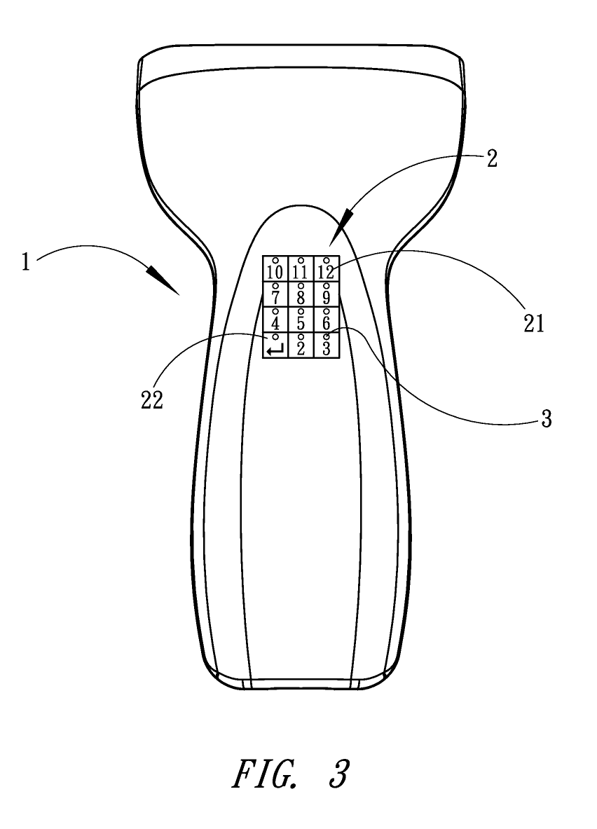

To ensure the quantity is input correctly and avoid errors, this invention places an LED indicator light 3 on the bar code scanner 1. This LED indicator light 3 can be a single one positioned at the end of the numeric keypad 2 as seen in FIG. 2, or be integrated into each numeric button 21 and the confirm button 22 as shown in FIG. 3. This LED indicator light 3 indicates different mode by on, off, blinking, or changing color like if a button was pressed and data was entered correctly. For example, when seeing the LED indicator light 3 on the bar code reader is on means a bar code is read successfully and is ready for quantity input, if a wrong button is pressed, just correct it by pressing the correct button followed by the confirm button.

When the quantity is more than 12, user can still enter the number from the cashier or POS machine.

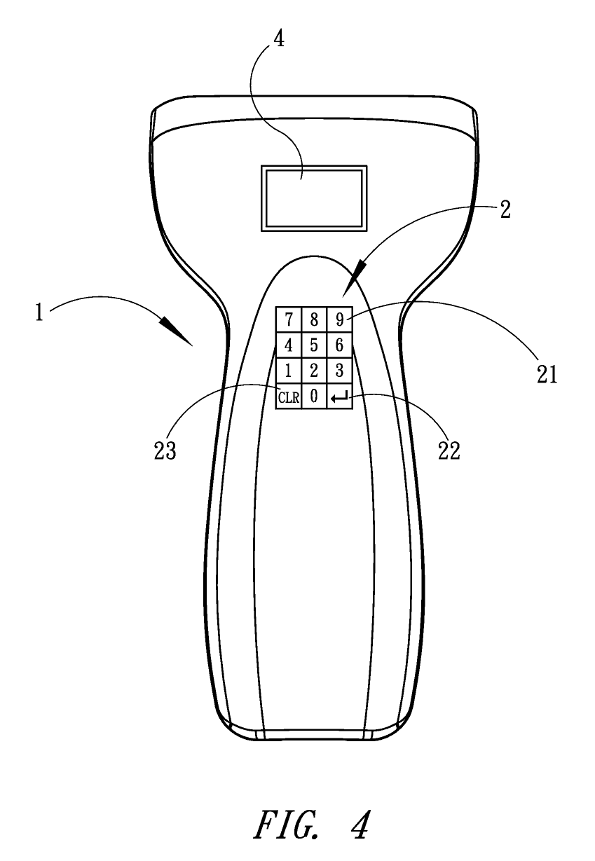

Because different retail situations will bring in different requirement, when the quantity is usually more than twelve, the bar code scanner 1 can use a LCD or LED display 4 as seen in FIG. 4 to show the input result of keypad so the user can easily know the scanning progress and easier to confirm or modify.

This configuration uses twelve buttons including ten numeric buttons 21 for number 0 to 9, a CLR clear button 23 and ENTER confirm button 22. Because of the display screen 4, it is easy to see the number input and if it is wrong, user can use the clear button 23 to delete it and input the correct number.

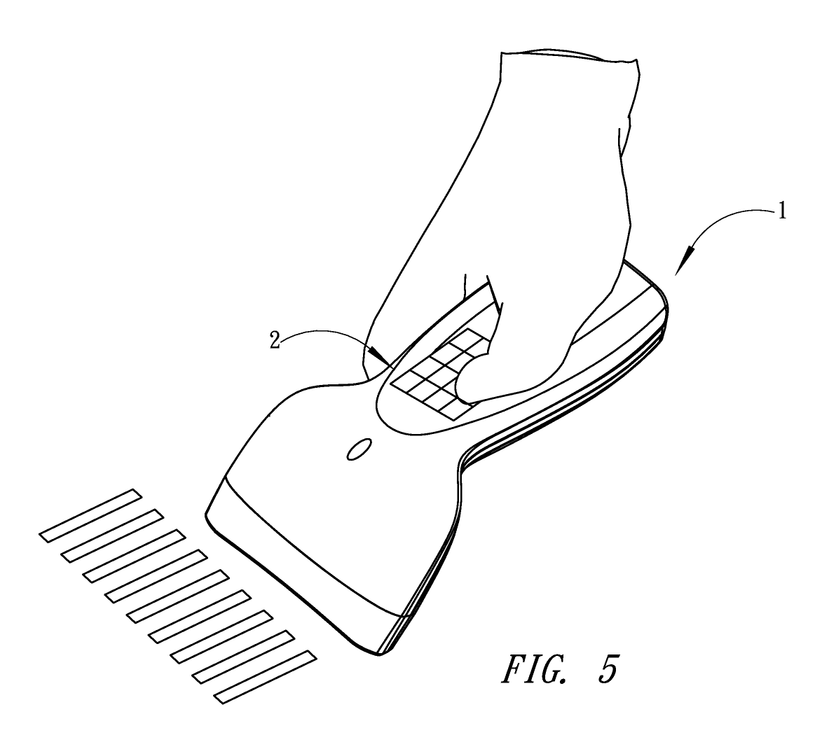

With this configuration as seen in FIG. 5, user holds this invention of numeric keypad embedded bar code scanner 1 and start scanning items. When processing multiple items with different quantity, user only needs to use the keypad 2 to input the quantity of the item before or after scanning it to have the correct item-quantity combination.

The aforementioned descriptions are solely for explaining the embodiments of the present invention and are not intended to limit the scope of the present invention. Any equivalent practice of modification within the spirit of the present invention should be treated as being within the scope of patent of the present invention.

What is claimed is:

1. A numeric keypad embedded bar code scanner comprising:
a bar code scanner; and
a set of keypad buttons having a plurality of buttons arranged in matrix embedded on the surface of the bar code scanner.

2. The numeric keypad embedded bar code scanner as claimed in claim 1, wherein the numeric keypad has a plurality of numeric buttons that individually represent a number for user to input the quantity of an item before or after scanning it by pressing the corresponding button.

3. The numeric keypad embedded bar code scanner as claimed in claim 1, wherein the numeric keypad has a confirm button for user to confirm the number input.

4. The numeric keypad embedded bar code scanner as claimed in claim 1, w h e r e i n t h e bar code scanner is integrated with an LED indicator to represent the input status by on, off, blinking, and changing color.

5. The numeric keypad embedded bar code scanner as claimed in claim 1, w h e r e i n t h e bar code scanner is integrated with an LCD or LED display screen to display the input information.

6. The numeric keypad embedded bar code scanner as claimed in claim 1, wherein the numeric keypad is a programmable module.
